(19) United States
(12) Patent Application Publication
(10) Pub. No.: US 2020/0407662 A1
(43) Pub. Date: Dec. 31, 2020

(54) CONCENTRATED SOLID LAUNDRY SOFTENER COMPOSITION

(71) Applicant: ECOLAB USA INC., Saint Paul, MN (US)

(72) Inventors: Emily Chen, Saint Paul, MN (US); Nathan D. Peitersen, Saint Paul, MN (US); Kaustav Ghosh, Saint Paul, MN (US); Derrick Anderson, Saint Paul, MN (US)

(21) Appl. No.: 16/946,544

(22) Filed: Jun. 26, 2020

Related U.S. Application Data
(60) Provisional application No. 62/868,390, filed on Jun. 28, 2019.

(51) Int. Cl. C11D 3/00; C11D 3/30; C11D 3/32; C11D 3/37; C11D 17/00; C11D 1/722

(52) U.S. Cl. CPC C11D 3/001; C11D 3/30; C11D 3/323; C11D 1/722; C11D 3/3742; C11D 17/0086; C11D 3/3738

(57) ABSTRACT

Solid laundry softening compositions for laundry applications of use are disclosed. In particular, solid laundry softening compositions combining high content and loading of quaternary ammonium compounds on a urea solidification aid in a ratio of at least about 1:1 to about 6:1 quaternary ammonium compound to urea are provided. The cast and extruded solid compositions can be provided as stable multi-use blocks having uniform dispensing rates and without block sloughing. Beneficially, the combination of quaternary ammonium compounds and urea can be provided in combination with softening boosters, processing aids, surfactants, and/or additional functional ingredients to provide stable solid composition.

### CROSS-REFERENCE TO RELATED APPLICATION

This application claims priority under 35 U.S.C. § 119 to Provisional Application U.S. Ser. No. 62/868,390, filed on Jun. 28, 2019, which is herein incorporated by reference in its entirety.

### FIELD OF THE INVENTION

The invention relates to solid laundry softening compositions and applications of use. In particular, the solid laundry softening compositions combine quaternary ammonium compounds with a urea solidification agent in a ratio of at least about 1:1 to about 6:1 quaternary ammonium compound to urea. The high quaternary ammonium compound ratio and content in the solid laundry softening compositions can be further combined with softening boosters, processing aids, surfactants, and/or additional functional ingredients to provide stable solid compositions that are processable and suitable for dispensing despite the high quaternary ammonium compound content in the solid compositions.

### BACKGROUND OF THE INVENTION

Alkaline detergents and strong mechanical action are well known for use in laundering applications, including industrial and consumer use in both automatic or manual washing processes. However, they can result in unpleasant hardened or rough feel after drying of the laundry or textile item. This is conventionally overcome by use of fabric softening compositions to bring back softness to the touch of the laundry or textile item. Fabric softener compositions are commonly used to deposit a fabric softening compound onto fabric. Typically, such compositions contain a cationic fabric softening agent dispersed in water. These fabric softening compositions are most often liquid compositions that are delivered into the rinsing bath. Rinse-added liquid softeners have certain benefits. For example, they are easy to handle, e.g., easy to dispense and to measure. The liquid softeners also minimize the potential for concentrated deposition of the softener on an area of a fabric to cause visible staining. To facilitate the use of liquid softeners, some automatic clothes washers built with an automatic fabric softener dispenser require the fabric softener in liquid form for proper dispensing.

There is an ongoing need and consumer demand for solid fabric softener compositions instead of liquids. This is for multiple reasons. For example, liquid fabric softener products can contain about 90% to about 95% of water. These products require a great amount of packaging material, the transport of large weight (making shipping expensive), and large shelf space in the retail stores. Although liquid concentrated compositions are available, there remain a significant water content in the liquid compositions. Moreover, any liquid formulation will have shorter shelf-stability than a solid composition.

Accordingly, there is a need for improved solid fabric softener compositions to take advantage of their benefits—compactness of the compositions for transportation, reduced shipment costs, less packaging, more readily disposable containers that can be used, less chance for messy leakage, and less shelf space required in the retail stores. Solid formulations are also more stable to storage, and extremes of temperature. Despite these many advantages of a solid composition, it is still a challenge to develop a formulation of a solid softener that has a performance comparable to a liquid softener with the same kind and amount of active content. It is still more challenging to formulate concentrated solids to provide high dosing of the active fabric softening agent.

Quaternary ammonium compounds have long been known in the art for their fabric softening capabilities in liquid formulations. However, it is a challenge to formulate such actives into a solid softener that will not melt, “weep”, or separate during typical storage and transport temperatures. Many preferred softening actives that are biodegradable, such as triethanolamine diester quats (one example of which is methyl bis(ethyl tallowate)-2-hydroxyethyl ammonium methyl sulfate), have a low melting point and are semi-solid at room temperature, and are much harder to formulate into a non-weeping product. As a result, common actives for liquid softeners are not suitable for use in formulating solid compositions. An additional challenge in producing a solid softener composition is developing a formulation that will have an adequate dispense rate when sprayed with water. Many common actives for fabric softening are hydrophobic and result in low dispensing rates which is undesirable. If the dispense rate is too slow it will not be possible to deliver the required amount of formulation during the normal rinse cycle. Another dispensing challenge is ‘weeping’ and sloughing of the solid composition, including during dispensing or during storage in between dispensing in the humid environment of a dispenser. As such there is a need for compositions and methods to formulate and use solid laundry softener compositions to overcome these challenges.

Accordingly, it is an object herein to provide a solid laundry softener composition that performs at least as well as traditional liquid compositions in a stable solid form.

It is yet another object herein to provide a solid laundry softener that can have a high quaternary ammonium compound loading onto a urea solid, including a multi-use solid composition, such as a solid block.

Other objects, advantages and features will become apparent from the following specification taken in conjunction with the accompanying drawings.

### BRIEF SUMMARY OF THE INVENTION

An advantage of the solid laundry softening compositions and methods of use thereof, is that the cast and extruded solid compositions having a high level of quaternary ammonium compound loaded onto the urea solidification aid while maintaining processability, dispensing and softening efficacy. A further advantage of the solid laundry softening compositions and methods of use thereof, is that the solid compositions can be further stabilized with a surfactant and/or one or more processing aids.

In an embodiment, a solid laundry softening composition comprises: from about 15-60 wt-% of a quaternary ammonium compound having the formula:

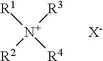

wherein R¹ and R² represent the same or different hydrocarbyl groups having from 8 to 24 carbon atoms, R³ and R⁴ represent the same or different hydrocarbyl groups containing 1 to about 4 carbon atoms, and X is an anion; and from about 1 wt-% to about 25 wt-% urea or occlusion compound forming derivatives; wherein the ratio of quaternary ammonium compound to urea or occlusion compound forming derivatives is from about 1:1 to about 6:1; and wherein the solid composition is dispensable and processable. In embodiments, the solid has a hardness of less than about 5 mm as measured by a penetrometer reading, the solid is dispensable as measured by dispensing with an SCLS dispenser at 50° C. with the conductivity of the dispensed solution of the solid composition being at least 1000 uS/cm within 1 minute, and the solid is processable as measured by having a processing viscosity that is below 20 Pa s at 75° C.

In a further embodiment, a solid laundry softening composition comprises from about 15-60 wt-% of a quaternary ammonium having the following formula:

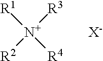

wherein R¹ and R² represent the same or different hydrocarbyl groups having from 12 to 24 carbon atoms, R³ and R⁴ represent the same or different hydrocarbyl groups containing 1 to about 4 carbon atoms, and X is an anion; from about 1 wt-% to about 25 wt-% urea or occlusion compound forming derivatives; a surfactant booster providing fabric softness and/or dispensing and processing improvement; wherein the ratio of quaternary ammonium compound to urea or occlusion compound forming derivatives is from about 1:1 to about 6:1; and wherein the solid composition is dispensable and processable. In embodiments, the solid has a hardness of less than about 5 mm as measured by a penetrometer reading, the solid is dispensable as measured by dispensing with an SCLS dispenser at 50° C. with the conductivity of the dispensed solution of the solid composition being at least 1000 uS/cm within 1 minute, and the solid is processable as measured by having a processing viscosity that is below 20 Pa s at 75° C.

In a still further embodiment, a method for treating fabric comprises: contacting a solid laundry softening composition with water to form an aqueous suspension, wherein the solid laundry softening composition is as described according to the embodiments herein, wherein the solid laundry softening composition is a stable, multi-use block having a hardness of less than about 7.5, 7, 6.5, 6, 5.5, preferably less than 5, 4.5, 4, 3.5, 3, 2.5, 2, 1.5, 1, or 0.5 mm as measured by a penetrometer reading; and dispensing the aqueous suspension into a washing machine, where it contacts the fabric to be treated. The fabric becomes a treated fabric item which is beneficially cleaned, softened or the like.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 depicts the results of fabric analysis with the phabrometer in terms of fabric softness of an embodiment.

FIG. 2 depicts the results of fabric analysis with the phabrometer in terms of fabric resilience of an embodiment.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments are not limited to particular solid laundry softening compositions, methods of making, and/or methods of using, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation, but the preferred materials and methods are described herein. In describing and claiming the embodiments, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “hygroscopic” as used herein refers to the ability of a material to take up and retain moisture. As referred to herein “non-hygroscopic” or “not hydroscopic” refers to a material or composition containing a material that when exposed to moisture, such as humidity, does not absorb moisture in an amount that would cause the material or composition to become liquid. Hygroscopic materials cause the solid to absorb water, resulting in a softer solid with lower penetrometer value in this context.

The term “laundry”, “linen,” “fabric,” and/or “textile” as used herein refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillowcases, towels, table linen, table cloth, bar mops and uniforms.

As used herein, the term “polymer” generally includes, but is not limited to, homopolymers, copolymers, such as for example, block, graft, random and alternating copolymers, terpolymers, and higher “x”mers, further including their derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sloughing” refers to large pieces or chunks of material falling out of or away from a solid composition during dispensing when water is used to bring a portion of a solid composition into an aqueous solution for dispensing. The pieces or chunks of solid material fall off the solid during or between dispensing in an unintentional and/or uncontrolled manner when the solid composition is softened by the dispensing water.

The term “solid” refers to a composition in a generally shape-stable form under expected storage conditions, for example a particle, agglomerate, flake, granule, pellet, tablet, lozenge, puck, briquette, brick or block, and whether in a unit dose or a portion from which measured unit doses may be withdrawn. A solid may have varying degrees of shape stability, but typically will not flow perceptibly and will substantially retain its shape under moderate stress, pressure or mere gravity, as for example, when a molded solid is removed from a mold, when an extruded solid exits an extruder, and the like. A solid may have varying degrees of surface hardness, and for example may range from that of a fused solid block whose surface is relatively dense and hard, resembling concrete, to a consistency characterized as less hard. In a preferred embodiment, the solid composition is a solid block and not loose powder or flowable powder.

The term “water soluble” refers to a compound that can be dissolved in water at a concentration of more than 1 wt. %.

As used herein, the term “weeping” refers to a predictive assessment for sloughing in a small scale sample size.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The compositions and methods described herein may comprise, consist essentially of, or consist of the components and ingredients as well as other ingredients described herein. As used herein, “consisting essentially of” means that the compositions and methods may include additional steps, components or ingredients, but only if the additional steps, components or ingredients do not materially alter the basic and novel characteristics of the claimed compositions and methods. It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

Solid Laundry Softening Compositions

The solid laundry softening compositions according to the disclosure comprise, consist of, and/or consist essentially of a quaternary ammonium compound (preferably a low iodine value quaternary ammonium compound) and a urea solidification agent. The solid compositions can also include a softening booster (e.g. silicone), processing aids, surfactant, and/or additional functional ingredients.

In embodiments, the solid compositions beneficially have high content or high loading of quaternary ammonium compound in the urea solid composition. In an embodiment, the ratio of quaternary ammonium compound to urea or occlusion compound forming derivatives is at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, or up to about 6.5:1. In additional embodiments, the ratio of quaternary ammonium compound to urea or occlusion compound forming derivatives is from about 1:1 to about 6:1. It is unexpected that a stable, processable solid can be formulated comprising such high loading and content of quaternary ammonium compound to urea.

Exemplary ranges of the solid laundry softening compositions are shown in Tables 1A-1C in weight percentage of the solid compositions.

TABLE 1A

| | First | Second | Third | Fourth |
|---|---|---|---|---|
| | Exemplary | Exemplary | Exemplary | Exemplary |
| | Range | Range | Range | Range |
| Material | wt-% | wt-% | wt-% | wt-% |
| Quaternary | 10-80 | 10-60 | 15-60 | 20-60 |
| Ammonium | | | | |
| Compound | | | | |
| Urea (Occlusion | 1-25 | 2-25 | 5-25 | 10-25 |
| compound | | | | |
| forming | | | | |
| derivatives) | | | | |
| Additional | 0-60 | 0.1-60 | 1-60 | 1-60 |
| Functional | | | | |
| Ingredients | | | | |

TABLE 1B

| | First | Second | Third | Fourth |
|---|---|---|---|---|
| | Exemplary | Exemplary | Exemplary | Exemplary |
| | Range | Range | Range | Range |
| Material | wt-% | wt-% | wt-% | wt-% |
| Quaternary | 10-80 | 10-60 | 15-60 | 20-60 |
| Ammonium | | | | |
| Compound | | | | |
| Urea (Occlusion | 1-25 | 2-25 | 5-25 | 10-25 |
| compound | | | | |
| forming | | | | |
| derivatives) | | | | |
| Softening | 0-20 | 0.5-20 | 1-15 | 1-10 |
| Booster (e.g. | | | | |
| Silicone) | | | | |
| Processing Aid | 0-10 | 0.5-7 | 0.5-5 | 1-4.5 |
| Surfactant | 0-20 | 0.1-15 | 0.5-15 | 1-12 |
| Additional | 0-60 | 0.1-60 | 1-60 | 1-60 |
| Functional | | | | |
| Ingredients | | | | |

TABLE 1C

| | First | Second | Third | Fourth |
|---|---|---|---|---|
| | Exemplary | Exemplary | Exemplary | Exemplary |
| | Range | Range | Range | Range |
| Material | wt-% | wt-% | wt-% | wt-% |
| Quaternary | 10-80 | 10-60 | 15-60 | 20-60 |
| Ammonium | | | | |
| Compound | | | | |
| Urea (Occlusion | 1-25 | 2-25 | 5-25 | 10-25 |
| compound | | | | |
| forming | | | | |
| derivatives) | | | | |
| Softening | 0.5-20 | 1-20 | 1-15 | 1-10 |
| Booster (e.g. | | | | |
| Silicone) | | | | |
| Processing Aid | 0-10 | 0.5-7 | 0.5-5 | 1-4.5 |
| Surfactant | 0-20 | 0.1-15 | 0.5-15 | 1-12 |
| Additional | 0-60 | 0.1-60 | 1-60 | 1-60 |
| Functional | | | | |
| Ingredients | | | | |

In some embodiments, the solid laundry softening compositions described in Tables 1A-1C have a hardness of less than about 5 mm as measured by a penetrometer reading. In some embodiments, the solid laundry softening compositions described in Tables 1A-1C are dispensable solids as measured by dispensing with an SCLS dispenser at 50° C. and the conductivity of the dispensed solution of the solid laundry softening composition is at least 1000 uS/cm within 1 minute. In some embodiments, the solid laundry softening compositions described in Tables 1A-1C are processable solids as measured by having a processing viscosity that is below 20 Pa s at 75° C. In some embodiments, the solid laundry softening compositions described in Tables 1A-1C have a hardness of less than about 5 mm as measured by a penetrometer reading, are dispensable solids as measured by dispensing with an SCLS dispenser at 50° C. and the conductivity of the dispensed solution of the solid laundry softening composition is at least 1000 uS/cm within 1 minute, and/or are processable solids as measured by having a processing viscosity that is below 20 Pa s at 75° C.

Quaternary Ammonium Compounds

The solid laundry softening compositions described herein include at least one quaternary ammonium compound. Quaternary ammonium compounds have the following general formula:

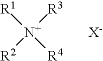

wherein R¹, R², R³, and R⁴ can each be C1-C24 aliphatic, normal or branched saturated or unsaturated hydrocarbon groups, alkoxy groups (R—O—), polyalkoxy groups, benzyl groups, allyl groups, hydroxyalkyl groups (HOR—), and the like, and X is an anion, preferably selected from halide, methyl sulphate or ethyl sulphate radicals. The quaternary ammonium compounds can include any anion or counter ion that allows the component to be used in a manner that imparts fabric-softening properties. Exemplary counter ions include chloride, methyl sulfate, ethyl sulfate, and sulfate.

Exemplary quaternary ammonium compounds for the solid laundry softening compositions have the following general formula:

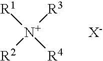

wherein R¹ and R² represent the same or different hydrocarbyl groups having from about 12 to about 24 carbon atoms, preferably from about 12 to about 22 carbon atoms, more preferably from about 14 to about 22 carbon atoms, or still more preferably from about 14 to about 20 carbon atoms; R³ and R⁴ represent the same or different hydrocarbyl groups containing about 1 to about 4 carbon atoms; and X is any suitable anion, such as a halide.

Preferred quaternary ammonium compounds have highly saturated carbon backbones (i.e. high degree of saturation of alkyl groups) of the hydrocarbyl groups. Preferably the quaternary ammonium compounds has two long R alkyl or alkenyl based chains (i.e. R¹ and R²) As referred to herein, “highly saturated” or a “high degree of saturation” with reference to the carbon backbones are represented by a low iodine value of the quaternary ammonium compounds, namely an iodine value equal to 15 or less.

Representative examples of these quaternary ammonium compounds include, for example, di(tallow alkyl)dimethyl ammonium methyl sulphate; dihexadecyl dimethyl ammonium chloride; di(hydrogenated tallow alkyl)dimethyl ammonium chloride; dioctadecyl dimethyl ammonium chloride; di(hydrogenated tallow alkyl)dimethyl ammonium methyl sulphate; dihexadecyl diethyl ammonium chloride; di(coconut alkyl)dimethyl ammonium chloride; ditallow alkyl dimethyl ammonium chloride; and di(hydrogenated tallow alkyl)dimethyl ammonium chloride, and combinations thereof.

Further representative examples of quaternary ammonium compounds useful in the solid laundry softening composition include but are not limited to mono-C8-C24 alkyl trimethyl quaternary ammonium compounds, monomethyl tri-C8-24 alkyl quaternary ammonium compounds, imidazolinium quaternary ammonium compounds, dimethyl-C8-24 alkylbenzyl quaternary ammonium compounds, complex di quaternary ammonium compounds, di-C8-24 alkyl dimethyl quaternary ammonium compounds, mono or dialkyl di or trialkoxy quaternary ammonium compounds, mono or dialkyl di or tripolyalkoxy quaternary ammonium compounds, (the alkoxy group being a methoxy, ethoxy or propoxy group or a hydroxyethyl or hydroxypropyl; the polyalkoxy being polyethoxy or polypropoxy group with 2-50 alkoxy groups), diamidoamine-methyl-C8-C22 alkyl-quaternary ammonium compounds, and di-C8-C22 alkyl methyl benzyl quaternary ammonium compounds.

The solid laundry softening compositions can preferably include a quaternary ammonium compound having sufficient saturated hydrocarbon groups, such as the alkyl groups, to have an iodine value equal to 15 or less. In a further embodiment, the solid laundry softening compositions can preferably include a dialkyl quaternary ammonium compound having saturated alkyl groups for R¹ and R² having from about 8 to about 24 carbon atoms, from about 12 to about 24 carbon atoms, preferably from about 12 to about 22 carbon atoms, more preferably from about 14 to about 22 carbon atoms, or still more preferably from about 14 to about 20 carbon atoms. In a preferred aspect, the dialkyl quaternary ammonium compound is a di(hydrogenated tallowalkyl)dimethyl ammonium chloride (DHTDMAC), DEEDMA(C) quat, or an ester quat.

Representative examples of quaternary ammonium compounds include, for example, alkyl benzyl ammonium chloride or alkyl dimethyl benzyl ammonium chloride (ADBAC), such as alkyl C12-C18 benzyl ammonium chloride, alkyl ethylbenzyl ammonium chloride or alkyl dimethyl ethylbenzyl ammonium chloride (ADEBAC), such as alkyl C12-C18 ethylbenzyl ammonium chloride, dialkyl ammonium salt or dialkyl dimethyl ammonium chloride, such as di alkyl C12-C18 di alkyl C1-C4 ammonium salt.

The solid laundry softening compositions can preferably include an amidoamine quaternary ammonium compound, including for example diamidoamine quaternary ammonium compounds. Exemplary diamidoamine quaternary ammonium compounds are available under the name Varisoft®. Exemplary amidoamine quaternary ammonium compounds include methyl-bis(tallow amidoethyl)-2-hydroxyethyl ammonium methyl sulfate, methyl bis(oleylamidoethyl)-2-hydroxyethyl ammonium methyl sulfate, and methyl bis(hydr.tallowamidoethyl)-2-hydroxyethyl ammonium methyl sulfate.

The solid laundry softening compositions can preferably include an imidazolinium quaternary compound. Exemplary imidazolinium quaternary ammonium compounds include methyl-1hydr. tallow amido ethyl-2-hydr. tallow imidazolinium-methyl sulfate, methyl-1-tallow amido ethyl-2-tallow imidazolinium-methyl sulfate, methyl-1-oleyl amido ethyl-2-oleyl imidazolinium-methyl sulfate, and 1-ethylene bis(2-tallow, 1-methyl, imidazolinium-methyl sulfate).

The solid laundry softening compositions can preferably include an alkylated quaternary compound. Exemplary alkylated quaternary ammonium compounds include ammonium compounds having an alkyl group containing between 6 and 24 carbon atoms. Exemplary alkylated quaternary ammonium compounds include monoalkyl trimethyl quaternary ammonium compounds, monomethyl trialkyl quaternary ammonium compounds, and dialkyl dimethyl quaternary ammonium compounds. The alkyl group is preferably C12-C24, C14-C24, C14-C22, or C14-C20 group that is aliphatic and saturated, straight or branched.

The solid laundry softening compositions can preferably include an ester quaternary compound. Ester quats refer to a compound having at least two or more alkyl or alkenyl groups connected to the molecule via at least one ester link. An ester quaternary ammonium compound can have at least one, or can have two or more ester links present. Exemplary ester quaternary ammonium compounds include for example, di-alkenyl esters of triethanol ammonium methyl sulphate and N,N-di(tallowoyloxy ethyl)N,N-dimethyl ammonium chloride, polyol ester quat (PEQ). Commercial examples of compounds include, but are not limited to, di-oleic ester of triethanol ammonium methyl sulphate, di-oleic ester of triethanol ammonium methyl sulphate, partially hardened tallow ester of triethanol ammonium ethyl sulphate, palm ester of triethanol ammonium methyl sulphate, hardened tallow ester of triethanol ammonium methyl sulphate, unsaturated carboxylic acid reaction products with triethanolamine dimethyl sulphate quaternized. Further examples include triethanolamine (TEA) ester quats (e.g., methyl bis(ethyl tallowate)-2-hydroxyethyl ammonium methyl sulfate), methyldiethanolamine (MDEA) ester quats, diamidoquats (e.g., methyl bis(hydrogenated tallow amidoethyl)-2-hydroxyethyl ammonium methyl sulfate), and dialkyldimethyl quats (e.g., dihydrogenated tallow dimethyl ammonium chloride). Preferred ester quats are those made from the reaction of alkyl carboxylic acid fraction, methyl ester and triglyceride with triethanolamine. Additional description of the ammonium quaternary fabric softening actives is disclosed in U.S. Pat. No. 4,769,159, which is herein incorporated by reference.

The ammonium quaternary laundry softening active employed, in some embodiments, has a low iodine value. Iodine values are a measurement of unsaturation of the alkyl chain or alkyl backbone of a quaternary ammonium compound. In an embodiment an iodine value of 15 or less, less than about 15, less than about 14, less than about 13, less than about 12, less than about 11, less than about 10, less than about 9, less than about 8, less than about 7, less than about 6, less than about 5, less than about 4, less than about 3, less than about 2, less than about 1, or even 0, and provides the beneficial solid quat formulations in combination with the silicone actives described herein. Iodine values can be calculated according to ASTM D5554-15, Standard Test Method for Determination of the Iodine Value of Fats and Oils wherein the same method is used for determining the iodine value of an alkyl chain or alkyl backbone of a quaternary ammonium compound.

In an embodiment, the quaternary ammonium compound is a biodegradable compound. In a further embodiment, the quaternary ammonium compound is a biodegradable compound having an iodine value of 15 or less.

In an embodiment one or more of the quaternary ammonium compounds are included in the solid composition in an amount of from about 5 wt-% to about 80 wt-%, 10 wt-% to about 80 wt-%, 15 wt-% to about 80 wt-%, from about 15 wt-% to about 60 wt-%, from about 25 wt-% to about 60 wt-%, preferably from about 25 wt-% to about 55 wt-% by weight based on the total weight of the solid laundry softening composition. In embodiments, the inclusion of a softening booster can reduce the concentration of quaternary ammonium compounds in the solid composition, such as at concentrations as low as about 5 wt-%.

Urea and Occlusion Compound Forming Derivative Solidification Agents

A urea or occlusion compound forming derivatives are included in the solid laundry softening compositions as a solidification agent. Urea may be in the form of prilled beads or powder.

In an embodiment, salts of urea are also included, such as urea citrate.

As referred to herein, occlusion compound forming derivatives includes urea occlusion complexes. Urea occlusion complexes have significant parts urea. An exemplary occlusion compound forming derivative is thiourea. In embodiments where an occlusion compound forming derivative is included instead of urea it is understood that water will need to be included in the composition for the urea occlusion solidification.

As one skilled in the art will ascertain, the solidification rate of the solid laundry softening compositions will vary, at least in part, according to the amount, and the particle size and shape of the urea added to the composition. In exemplary embodiments described herein, a particulate form of urea is combined with the quaternary ammonium compound and other ingredients. The urea forms a matrix with the additional ingredients in the composition which hardens to a solid. Beneficially, the amount of urea included in the composition is effective to provide a cast and/or extruded solid material having surfaces that are stabilized to the effects of atmospheric humidity. The urea can also help provide a hardness and desired rate of solubility of the composition when placed in an aqueous medium to achieve a desired rate of dispensing the from the solidified composition during use.

In an embodiment one or more of the urea and occlusion compound forming derivatives are included in the solid composition in an amount of from about 1 wt-% to about 25 wt-%, from about 2 wt-% to about 25 wt-%, from about 5 wt-% to about 25 wt-%, or from about 10 wt-% to about 25 wt-%. In additional embodiments, the one or more of the urea and occlusion compound forming derivatives are included in the solid composition in an amount of from about 1 wt-% to about 20 wt-%, from about 5 wt-% to about 20 wt-%, or from about 10 wt-% to about 20 wt-% by weight based on the total weight of the solid laundry softening composition.

Softening Booster

The solid laundry softening compositions can optionally include a softening booster. Softening boosters include silicone compounds and polymers, deposition aids, such as cationic celluloses and cationically charged polymers, such as polyquaterniums, guar derivatives, and other boosters that do not function alone as softeners, instead boost the softness of the quaternary ammonium compound.

In an embodiment, at least one silicone compound or polymer for added softening benefit in combination with the quaternary ammonium compound is included. The silicone compound or polymer boosts the softness of the quaternary ammonium compound in addition to providing active softness. Suitable silicones include those having hydrophilic functionality, such as an organosilicone, such as: a polyalkyl silicone, an aminosilicone, a siloxane, a polydimethyl siloxane, an ethoxylated organosilicone, a propoxylated organosilicone, an ethoxylated/propoxylated organosilicone, and mixtures thereof.

In one embodiment, the organosilicone is an aminofunctional silicone or silicone quaternary ammonium compound, hydroxyl modified silicone, or silicone with an incorporated hydrophilic group, and emulsions thereof. Examples of incorporated hydrophilic groups include for example, EO/PO or PEG modified silicones).

Organosilicones not only provide softness and smoothness to fabrics, but also provide a substantial color appearance benefit to fabrics, especially after multiple laundry washing cycles. Exemplary organosilicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C. Suitable organosilicones may be linear, branched or cross-linked. Suitable organosilicones may be in the form of neat liquids, combinations with solvents, or emulsions in water. If aqueous emulsions are used, the preferred silicones are as concentrated as possible to minimize the amount of liquid added to the composition, since large amounts of liquid can complicate the solidification process.

A linear or branched structured silicone polymer can also be used in the solid laundry softening compositions. The silicone of the present invention can further be a single polymer or a mixture of polymers. In a preferred aspect the silicone is an amino-functional silicone which can be a linear or branched structured amino-functional silicone polymer and can further be a single polymer or a mixture of polymers, including a mixture of polymers wherein one of the polymers contains no amino functionality, e.g., a polydimethylsiloxane polymer.

In a preferred aspect, the silicone does not include ester based polysiloxanes. In particular, the ester based polysiloxanes include those polymers with a cleavable bond as described in U.S. Publication No. 2019/0024018, the disclosure of which is incorporated by reference. These polysiloxanes excluded from the silicone compound of the solid compositions include siloxane polymers having at least one unit of the following formula (I):

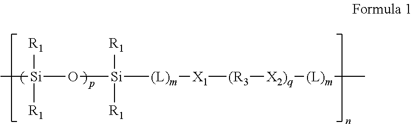

wherein:
(a) L is a linking bivalent alkylene radical, each R₂ is independently selected from the group consisting of H, C₁-C₄ alkyl, substituted alkyl, aryl, substituted aryl, and combinations thereof, each s is independently an integer of from 2 to about 12; each y is independently an integer of from 1 to about 100,
(b) each X₁ and X₂ is independently selected from the group consisting of:

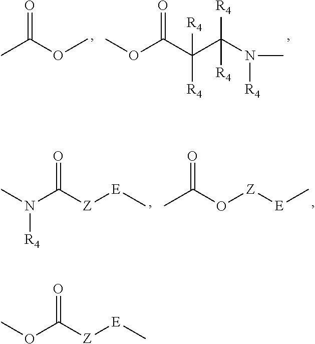

E=electron withdrawing group, each of R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; and each Z is independently selected from the group consisting of:

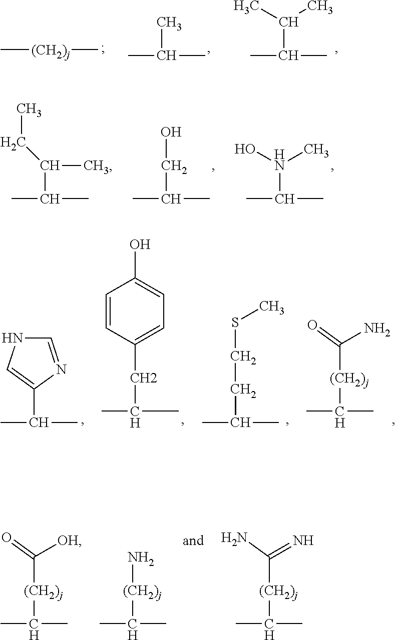

the index j is an integer from 1-32,
(c) each R₁ is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy,
(d) each R₃ is independently selected from the group consisting of C₁-C₃₂ alkylene, C₁-C₃₂ substituted alkylene, C₆-C₃₂ aryl, C₅-C₃₂ substituted aryl, C₆-C₃₂ alkylenearyl, and C₅-C₃₂ substituted alkylenearyl,
(e) each index m is one or zero,
(f) each q is 1 or zero,
(g) each index p is an integer of from about 2 to about 1000, and
(h) the index n is an integer of from about 1 to about 50.

Cationic cellulose and cationically charged polymers, such as polyquaterniums can be used as a softening booster. The term polyquaternium is the International Nomenclature for Cosmetic Ingredients (INCI) designation for various polycationic polymers, including polyquaternium 1-47. For example, polyquaternium-4 is a hydroxyethyl cellulose dimethyl diallylammonium chloride copolymer, polyquaternium-10 is a quaternized hydroxyethyl cellulose, and polyquaternium-24 is a hydroxyethyl cellulose or hydoxypropylcellulose quaternized with glycidyl C12-C22 alkyl dimethyl ammonium chloride. Exemplary polyquaterniums for softening boostening include, for example, Polyquaternium-1, Polyquaternium-5, Polyquaternium-6, Polyquaternium-7, Polyquaternium-8, Polyquaternium-10, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients. Various polyquaterniums are commercially available including Flosof LS407 and 447 from SNF Floerger, SOFTCAT SK from Dow Chemicals, CELQUAT H200 and CELQUAT L-200 from National Starch and Chemical Company.

An exemplary grouping of softening boosters include the cationic cellulosic polymers cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, Polyquaternium-4, Polyquaternium-10, Polyquaternium-24 and Polyquaternium-67 or mixtures thereof.

Additional examples of boosters can include starches that have been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. The source of starch before chemical modification can be chosen from a variety of sources including tubers, legumes, cereal, and grains. Non-limiting examples of this source of starch may include corn starch, wheat starch, rice starch, waxy corn starch, oat starch, cassaya starch, waxy barley, waxy rice starch, glutenous rice starch, sweet rice starch, amioca, potato starch, tapioca starch, oat starch, sago starch, sweet rice, or mixtures thereof. Nonlimiting examples of cationic starches include cationic maize starch, cationic tapioca, cationic potato starch, or mixtures thereof. The cationic starches may comprise amylase, amylopectin, or maltodextrin. The cationic starch may comprise one or more additional modifications. For example, these modifications may include cross-linking, stabilization reactions, phophorylations, hydrolyzations, cross-linking. Stabilization reactions may include alkylation and esterification.

Guar derivatives, including nonionic guars and cationic guars, in addition to a mixture of nonionic and cationic guars, such as Easysoft from Solvay (mixture of hydrophobically modified nonionic guar and cationic guar) can be used as softening boosters. Cationic guar gums are a quaternary ammonium derivative of hydroxypropyl guar such as those sold under the trade name JAGUAR from Rhodia, Inc. Additional examples of cationic polymers include polysaccharide polymers, cationic guar gum derivatives, quaternary nitrogen-containing cellulose ethers, synthetic polymers, copolymers of etherified cellulose, guar and starch.

Exemplary cationic polymers include those produced by polymerization of ethylenically unsaturated monomers using a suitable initiator or catalyst, and also include synthetic polymers made by polymerizing one or more cationic monomers, including N,N-dialkylaminoalkyl acrylate, N,N-dialkylaminoalkyl methacrylate, N,N-dialkylaminoalkyl acrylamide, N,N-dialkylaminoalkylmethacrylamide, quaternized N, N dialkylaminoalkyl acrylate quaternized N,N-dialkylaminoalkyl methacrylate, quaternized N,N-dialkylaminoalkyl acrylamide, quaternized N,N-dialkyl aminoalkylmethacrylamide, Methacrylo amidopropyl-pentamethyl-1,3-propylene-2-ol-ammonium dichloride, N,N,N,N′,N′,N″,N″-heptamethyl-N″-3-(1-oxo-2-methyl-2-propenyl)aminopro-pyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally an additional monomer including acrylamide, N,N-dialkyl acrylamide, methacrylamide, N,N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. In other embodiments, the cationic polymer backbone does not contain a cationic monomer and instead provides a cationic functionality.

In embodiments employing a softening booster, the softening booster is present at a level in the range of from about 0.1 wt-% to about 20 wt-%, from about 0.5 wt-% to about 20 wt-%, from about 1 wt-% to about 20 wt-%, from about 0.1 wt-% to about 10 wt-%, from about 0.1 wt-% to about 5 wt-%, from about 1 wt-% to about 10 wt-%, or from about 1 wt-% to about 5 wt-% based on the total weight of the solid laundry softening composition. In some embodiments, non-silicone boosters are present a level in the range of from about 0.01 wt-% to about 10 wt-%, from about 0.1 wt-% to about 10 wt-%, from about 0.1 wt-% to about 5 wt-%, or from about from about 0.1 wt-% to about 2 wt-%.

Without being limited to a particular mechanism of action the ratio of the dialkyl quaternary ammonium compound to the silicone or other softening booster in the solid laundry softening composition provides efficacious softening without deleterious effects on treated surfaces when provided in a ratio less than about 3:1, preferably from about 2.4:1 to about 1.8:1, or most preferably from about 2:1.

Additional Functional Ingredients

The components of the solid laundry softening compositions can further be combined with various functional components suitable for use in laundry softening applications and/or processing and forming the solid laundry softening compositions. In some embodiments, the solid composition including the quaternary ammonium compound and urea or occlusion compound forming derivative make up a large amount, or even substantially all of the total weight of the solid composition. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution or suspension, provides a beneficial property in fabric softening and/or maintaining stability and suitable processing and/or dispensing of the solid composition. Some particular examples of functional materials are discussed in more detail below, although the particular materials discussed are given by way of example only, and that a broad variety of other functional ingredients may be used.

In embodiments, the compositions may include salts, defoaming agents, anti-redeposition agents, solubility modifiers, dispersants, stabilizing agents, sequestrants and/or chelating agents, surfactants (including nonionic surfactants), anti-wrinkling agents, optical brighteners, fragrances and/or dyes, rheology modifiers or thickeners, hydrotropes or couplers, buffers, solvents, enzymes, soil-release agents, dye scavengers, starch/crisping agent, germicides/fungicides, antioxidants or other skin care components, sanitizers and components for residual protection, and the like.

Processing Aid

Processing aids can provide advantageous features to the solid compositions, such as for example, improve processability, dispensability, and softness. In an embodiment, the processing aid for solidification includes one or more non-deliquescent materials. Beneficially, including a non-deliquescent material provides a non-hygroscopic material such that when the solid composition is exposed to humidity (such as during the dispensing of a solid composition) the composition does not absorb water or does not absorb sufficient water to become liquid. This is important due to the dispensing challenges, namely humid environments that the solid compositions are exposed to.

The solid laundry softening compositions may include one or more processing aids that have a medium to long chain alkyl group. In an embodiment, the processing aid has at least a C6 alkyl group.

The solid laundry softening compositions may include one or more processing aids that are medium to long chain fatty carboxylic acids. Exemplary fatty acids, such as a free fatty acids can be employed and the term “fatty acid” is used herein in the broadest sense to include unprotonated or protonated forms of a fatty acid. One skilled in the art will readily appreciate that the pH of an aqueous composition will largely determine whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise). The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms. The fatty acids may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, castor oil, etc.; (3) processed and/or bodied oils, such as linseed oil or tung oil via thermal, pressure, alkali-isomerization and catalytic treatments; (4) combinations thereof, to yield saturated (e.g. stearic acid), unsaturated (e.g. oleic acid), polyunsaturated (linoleic acid), branched (e.g. isostearic acid) or cyclic (e.g. saturated or unsaturated disubstituted cyclopentyl or cyclohexyl derivatives of polyunsaturated acids) fatty acids. Mixtures of fatty acids from different fat sources can be used.

Suitable carboxylic acids may be saturated or unsaturated, but are preferably saturated carboxylic acids. These carboxylic acids have at least 6 carbon atoms, or from about 6 to about 22 carbon atoms on the alkyl or alkenyl chain, and are in either straight chain or branched chain configuration, preferable carboxylic acids are in straight chain configuration having at least 6 carbon atoms, preferably from about 12 to about 22 carbon atoms. Non-limiting examples of useful carboxylic acids include lauric acid (C12), stearic acid (C18), palmitic acid (C16) or behenic acid (C22). Additional examples include long chain fatty acids or its salt, such as stearic acid, palmitic acid, coco fatty acid, stearic monoethanolamide, coco-monoethanolamide, and the like. Without being limited to a particular mechanism of action or theory of the invention, the C6-C22 alkyl groups, such as C6-C22 alkyl chains of the carboxylic acid, stabilizing agents are preferred as they readily form hard, low-melting urea occlusion complexes and are compatible with quaternary ammonium compounds.

Additional processing aids can include LMEA (lauric monoethanolamide), SMEA (stearic monoethanolamide), etc. Various hydrophobic species that are solid at room temperature are suitable for use as stabilizing agents, including but not limited to: palmitic acid, coco fatty acid, lauric monoethanolamide, stearic monoethanolamide, coco-monoethanolamide, fatty acids described above. Additional stabilizng agents can include alkyl quaternary ammonium compounds.

When included in the solid laundry softening composition the processing aid is present at a level of from about 0.1% to about 10.0%, from about 0.1% to about 7.0%, or from about 0.1% to about 5.0% by weight based on the total weight of the composition.

Salts

Salts may also be included in the solid laundry softening compositions in combination with the urea or occlusion compound forming derivatives to aid in the solidification matrix, preferably water-soluble salts. Salts, including water soluble salts, can be either organic or inorganic. Water soluble salts include a salt of a polycarboxylic acid, which is an acid with more than one carboxylate group, including for example diacids and triacids such as citrate. Water soluble salts include salts of acids such as carboxylic acids (aliphatic, acetic, formic), aromatic (benzoic, salicylic) or dicarboxylic acids such as oxalic, phthalic, sebacic, adipic, glutaric; tricarboxylic acids such as citric acid, carboxylic acids such as aliphatic (oleic, palmitic, stearic), or aromatic (phenylstearic), or even water soluble amino acids or salts such as those having sodium, potassium, aluminum, magnesium, titanium, ammonium, triethanolamine, diethanolamine and/or monoethanolamine as the cation. Salts can also include neutral salts, including for example, sulphates and the like. A preferred salt of an acid is sodium citrate and/or monosodium citrate.

In embodiments where a salt is included in the solid composition, the salt is present at a level in the range of from about 0 wt-% to about 50 wt-%, from about 5 wt-% to about 50 wt-%, from about 5 wt-% to about 50 wt-%, from about 10 wt-% to about 50 wt-%, preferably from about 15 wt-% to about 50 wt-%, or preferably from about 20 wt-% to about 40 wt-%, based on the total weight of the solid laundry softening composition.

Acids

The solid laundry softening compositions may also include an acid (also referred to as a ‘sour’). Unexpectedly, the acids combined with the other ingredients in the composition, namely the urea are compatible, although they are traditionally incompatible. Without being limited to a particular mechanism of action, the acids are compatible as provided as weak acids that do not significantly destabilize the urea occlusion structure. In an embodiment, one or more acids can be included in the solid laundry softening compositions.

A wide range of acidic materials can be used including, but not limited to: oxalic acid, citric acid, gluconic acid, tartaric acid, nitrilotriacetic acid, ethylenediamine tetraacetic acid, amino tri(methylene phosphonic) acid, 1-hydroxyethylidine-1,1-diphosphonic acid, hexamethylene diamine tetra(methylene phosphonic acid), ammonium or sodium bifluoride, ammonium or sodium silicofluoride, ammonium or sodium bisulfate, ammonium or sodium bisulfate, hydroxyacetic acid, phosphoric acid, sulfamic acid. In further embodiments, salts of acids may also be employed, including for example, urea citrate and sodium citrate.

In an embodiment, a preferred class of acids are polycarboxylic acids such as dicarboxylic acids. The acids which are preferred include adipic, glutaric, succinic, and mixtures thereof. A preferred acidulant is a mixture of adipic, glutaric and succinic acid, which is a raw material sold by BASF under the name SOKALAN® DCS.

In an embodiment, a weak acid is compatible with the solid urea and quaternary ammonium compounds. Without being limited to a particular mechanism of action or theory of the invention, a strong acid can form complexes with urea, destabilizing a solid composition.

In some applications, it is preferred to use an acid that not only affects the pH, but also is capable of chelating iron over the pH range of 2 to 8. Dissolved iron in both ferric and ferrous oxidation states is found in many water supplies used for laundering fabrics. Iron can enter the water supply from the water source whether groundwater or surface water or from iron pipes either used in the municipal water supply or for plumbing at the site. Even small amounts of dissolved iron, less than 0.5 ppm, can cause white fabrics to yellow or colored fabrics to discolor over time. Water softening equipment used to remove the calcium and magnesium ions from hard water does not completely remove troublesome iron ions from the water. Preferred iron chelating acids include citric acid, gluconic acid and amino tri(methylene phosphonic acid). In exemplary embodiments, citric acid and its salts are preferred acids since it acidifies, buffers in the proper range, chelates iron and is mild to fabrics and skin. In addition, the citric acid and its salts do not destabilize the urea complexes

The acid concentration in the solid composition range from about 0 wt-% to about 20 wt-%, from about 1 wt-% to about 15 wt-%, from about 2 wt-% to about 15 wt-%, or from about 2 wt-% to about 12 wt-%.

Surfactants

The solid composition may also include surfactants. In some embodiments surfactant(s) is included as a processing aid (processing and dispensing). In further embodiments surfactant(s) is included for imparting softness. The surfactant concentration in the solid composition range from about 0 wt-% to about 20 wt-%, from about 0.1 wt-% to about 15 wt-%, from about 0.5 wt-% to about 15 wt-%, or from about 1 wt-% to about 12 wt-%.

Preferably, surfactants utilized include those selected from water soluble or water dispersible nonionic or semi-polar nonionics, cationic, amphiphilic, anionic or any combination thereof. In an embodiment, nonionic or cationic surfactants are preferred due to compatibility with quaternary ammonium compounds.

Nonionic Surfactants

Also useful in the present invention are surface active substances which are categorized as nonionics. Preferred nonionic surfactants useful in the solid compositions, include alcohol ethoxylate surfactants. Non-limiting examples of commercially available alcohol ethoxylate nonionic surfactants include: Tomadol 25-7 available from Tomah; Dehypon LS 54 available from Henkel; Pluronic N-3, Plurafac LF-221, Plurafac D-25, and SLF-18 available from BASF. Additional Pluronics may include block copolymers, such as Pluronics F-108 (Poly(ethylene glycol)-block-poly(propylene glycol)-block-poly(ethylene glycol)).

Useful nonionic surfactants include:

1. Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and the hydrophile, ethylene oxide, is added to constitute from about 10% by weight to about 80% by weight of the molecule.

2. Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

3. Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Utensil™, Dehydol™ manufactured by BASF, Neodol™ manufactured by Shell Chemical Co. and Alfonic™ manufactured by Vista Chemical Co.

4. Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present invention containing amylase and/or lipase enzymes because of potential incompatibility.

Examples of nonionic low foaming surfactants include:

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

7. The alkylphenoxypolyethoxyalkanols of U.S. Pat. No. 2,903,486 issued Sep. 8, 1959 to Brown et al. and represented by the formula

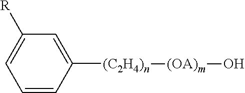

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)nOH]z wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

8. Polyhydroxy fatty acid amide surfactants suitable for use in the present compositions include those having the structural formula R₂CON_{R1}Z in which: R₁ is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

9. The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms, more preferably between 10 and 18 carbon atoms, most preferably between 12 and 16 carbon atoms.

10. The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

11. Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

12. Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

13. A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜN, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions of the invention include alcohol alkoxylates, EO/PO block copolymers, alkylphenol alkoxylates, and the like.

In a preferred embodiment a nonionic surfactant having an alkyl chain of at least C6, C8, C10, or C12 with an HLB between about 10-15 is preferred. Without being limited to a particular mechanism of action or theory of the invention, nonionic surfactants having a long alkyl chain and an HLB between about 10-15 beneficially improve dispensing of the solid composition without disrupting processability or product hardness as described herein.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

Cationic Surfactants

Also useful in the compositions are surface active substances which are categorized as cationic surfactants if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The simplest cationic amines, amine salts and quaternary ammonium compounds can be schematically drawn thus:

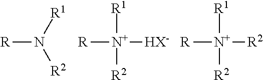

in which, R represents an alkyl chain, R′, R″, and R′″ may be either alkyl chains or aryl groups or hydrogen and X represents an anion.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like.

Cationic surfactants useful in the compositions include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

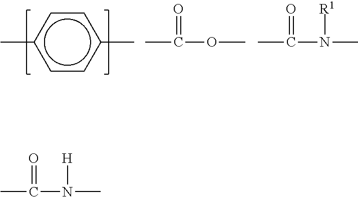

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is can be a group including, but not limited to:

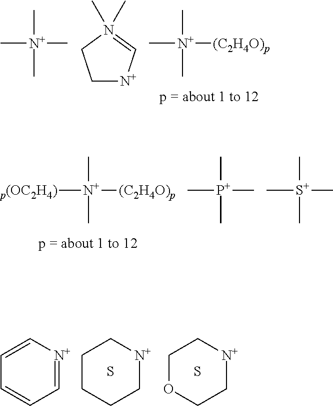

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Anionic Surfactants

Also useful in the compositions are surface active substances which are categorized as anionic surfactants. Anionic surfactants have a negative charge on the hydrophobe; or the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

Exemplary anionic sulfate surfactants include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Suitable anionics also include alkyl sulfonates, the linear and branched primary and secondary alkyl sulfonates, and the aromatic sulfonates with or without substituents.

Additional suitable anionics include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g. up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C22 alkyl group or

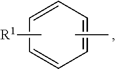

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

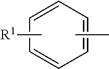

and R¹ is a C₆-C₁₂ alkyl group. In still yet other embodiments, R¹ is a C₉ alkyl group, n is 10 and m is 1.

Amphiphilic Surfactants

Also useful in the compositions are surface active substances which are categorized as amphiphilic surfactants. Amphiphilic (or amphoteric) surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphino. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Amine oxides are tertiary amine oxides corresponding to the general formula:

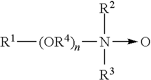

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 18 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Suitable amine oxides can include those selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide. An exemplary commercially available cocoamine oxide surfactant is BARLOX 12, available from Lonza.

Suitable long chain imidazole derivatives may generally have the general formula:

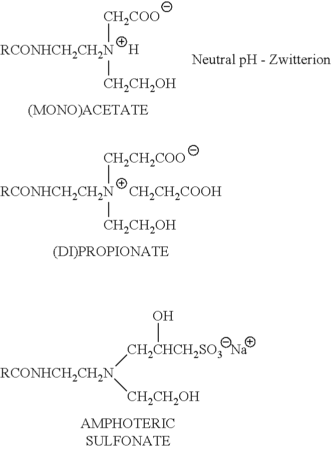

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes which are suitable include, without limitation, alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺ (CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J. A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch), which is herein incorporated by reference in its entirety.

Salt for Conductivity

The solid composition may also include at least one additional salt as an additional processing aid. In an embodiment, the additional salt is a salt for conductivity and/or is an inorganic anion or non-sequestering organic anion to allow for standard measurements of conductivity of the wash solution. Sodium chloride is preferably used, however a wide variety of ionizable salts can be used. Examples of suitable salts are the halides and acetates of the group IA metals of the Periodic Table of the Elements, for example, lithium chloride, sodium chloride, potassium chloride, ammonium chloride, sodium bromide, potassium bromide, calcium bromide, sodium iodide, potassium iodide, sodium acetate, potassium acetate, or mixtures thereof. Sodium chloride is preferred. The ionizable salts are particularly useful during the process of mixing the ingredients to make the compositions herein, and later to obtain the desired conductivity for measurement of dispersement rates of the softening composition. The amount of ionizable salts used depends on the amount of active ingredients used in the compositions and can be adjusted according to the desire of the formulator.

In a preferred embodiment, a salt for conductivity included in the solid compositions preferably has a solubility of at least about 5 ppm at 45° C. In preferred embodiments, a salt for conductivity included in the solid compositions preferably has a solubility above stearic acid.

The salt for conductivity, such as sodium chloride can be present at a level of from about 0% to about 60% by weight based on the total weight of the composition preferably from about 1% to about 50% by weight based on the total weight of the solid laundry softening composition.

Dispersant

A dispersant may be included to help remove soils and microorganisms from articles and surfaces. Examples of dispersants include, but are not limited to, to water soluble polymers, surfactants, hydrotropes, and wetting agents. In a preferred embodiment the dispersant is an anionic surfactant. The composition need not include a dispersant, but when a dispersant is included it can be included in an amount that provides the desired dispersant properties. Suitable ranges of the dispersant in the composition can be up to about 20 wt-%, about 0.5 to about 15 wt-%, or about 2 to about 9 wt-%.

Fragrance

The solid composition may also include any softener compatible fragrance/perfume. Suitable perfumes are disclosed in U.S. Pat. No. 5,500,138, said patent being incorporated herein by reference.

Methods of Making the Solid Compositions

The solid laundry softening compositions shown in Tables 1A-1C can be solidified as cast and/or extruded solids. The solid compositions can be manufactured in commonly available mixing equipment. In embodiments, the liquid materials can be adapted to a solid by incorporating into the composition a solidification agent, namely the urea (occlusion compound forming derivatives), and the solidification process is the urea occlusion process. An inclusion complex solidifying scheme is set forth in U.S. Pat. No. 4,647,258, which is incorporated herein by reference. An additional solidifying scheme is set forth in U.S. Pat. No. 5,674,831, which is incorporated herein by reference.

In some embodiments, in the formation of a solid composition, a mixing system may be used to provide for continuous mixing of the ingredients at high enough shear to form a substantially homogeneous solid or semi-solid mixture in which the ingredients are distributed throughout its mass. The mixture is processed at a temperature to maintain the physical and chemical stability of the ingredients. An ingredient may be in the form of a liquid or a solid such as a dry particulate, and may be added to the mixture separately or as part of a premix with another ingredient. One or more premixes may be added to the mixture. The ingredients are mixed to form a substantially homogeneous consistency wherein the ingredients are distributed substantially evenly throughout the mass. The mixture can be discharged from the mixing system through a die or other shaping means. The profiled extrudate then can be divided into useful sizes with a controlled mass.

The composition hardens due to the chemical or physical reaction of the requisite ingredients forming the solid. The solidification process may last from a few minutes to about six hours, or more, depending, for example, on the size of the cast or extruded composition, the ingredients of the composition, the temperature of the composition, and other like factors. In some embodiments, the cast or extruded composition “sets up” or begins to hardens to a solid form within about 1 minute to about 3 hours, or in the range of about 1 minute to about 2 hours, or in some embodiments, within about 1 minute to about 20 minutes.

In some embodiments, the extruded solid can be packaged, for example in a container or in film. The temperature of the mixture when discharged from the mixing system can be sufficiently low to enable the mixture to be cast or extruded directly into a packaging system without first cooling the mixture. The time between extrusion discharge and packaging may be adjusted to allow the hardening of the composition for better handling during further processing and packaging. In some embodiments, the mixture at the point of discharge is in the range of about 20° C. to about 90° C., or in some embodiments, in the range of about 25° C. to about 55° C. The composition is then allowed to harden to a solid form that may range from a low density, sponge-like, malleable, caulky consistency to a high density, fused solid, concrete-like solid.

Solid Compositions

The solid laundry softening compositions are preferably multi-use solid compositions formed by combining the components in the weight percentages and ratios disclosed herein. The solid compositions are provided as a solid and a use solution, wherein the use solution is a suspension, is formed during the dispensing and/or laundering process.

The solid compositions are substantially homogeneous with regard to the distribution of ingredients throughout its mass and are dimensionally stable.

The solid compositions can be a cast or extruded solid. The resulting solid may take forms including, but not limited to pellet, block, or tablet. In a preferred embodiment the solids do not include loose or flowable powders, the compositions are solid blocks with dimensional stability, as measured by a growth exponent of less than 3% if heated to a temperature of 120 F taking into account change in any dimension of the solid composition. In an exemplary embodiment, the solids can have a weight of at least about 50 grams, at least about 100 grams, at least about 250 grams, at least about 1 kilogram, or at least about 10 kilograms.

In some embodiments, the solid laundry softening compositions have a hardness of less than about 0.5 mm as measured by a penetrometer reading.

In some embodiments, the solid laundry softening compositions are dispensable as measured by dispensing with an Ecolab SCLS dispenser at 50° C. and the conductivity of the dispensed solution of the solid laundry softening composition reaches at least 1000 uS/cm within 1 minute.

In further embodiments, the solid laundry softening compositions are considered processable as measured by having a processing (i.e. making the solid composition) viscosity that is below 20 Pa s at 75° C.

In some embodiments, the solid composition may be dissolved, for example, in an aqueous or other medium, to create a concentrated and/or use solution. The solution may be directed to a storage reservoir for later use and/or dilution, or may be applied directly to a point of use in the laundering application. The solid compositions are beneficially designed as multi-use solids, such as blocks, and can be repeatedly used as a solid laundry softening composition for multiple cycles.

Methods of Use

The solid laundry softening compositions are suitable for consumer and industrial laundering applications. Accordingly, single use and multi-use solid compositions can be provided according to the embodiments described here.

Generally for the laundry (i.e. fabric/textile) softening process, the solid softening composition is dispensed by contacting a solid with a sufficient amount of water to dissolve at least a portion of the solid laundry softening composition, thereby forming a dissolved portion of the solid laundry softening composition that can then be added to the rinse cycle of the laundry process. The use solution of the laundry softening composition contacts the fabrics in need of treatment. The fabric becomes a treated fabric item which is beneficially cleaned, softened or the like according of the laundry process.

The water temperature for dispensing should be from about 40° C. to about 60° C., preferably from about 45° C. to about 55° C. The formulations of the present invention preferably dispense at greater than 10 grams/minute, more preferably greater than 15 grams/minute, and most preferably greater than 20 grams/minute without experiencing any weeping, sloughing or chunking in the dispensing of the multi-use solid blocks. The dispensing of the solid compositions described herein beneficially provide a non-weeping solid composition wherein the mass loss of the solid composition is less than about 10 grams per 100 grams (10%) at a temperature of up to 120° F. for 72 hours.

The diluted liquid compositions formed from the solid compositions disclosed herein are preferably used in the rinse cycle of the conventional automatic laundry operations. Generally, rinse water has a temperature from about 5° C. to about 60° C.

Fabrics or fibers are contacted with an amount of the solid softening composition that is effective to achieve the desired level of softness. The amount used is based upon the judgment of the user, depending on concentration of the softening material, fiber or fabric type, degree of softness desired, and the like. The amount of softener dispensed is typically characterized as the ratio of the amount of softening quaternary ammonium compound active to the amount of linen. This ratio is preferably in the range of from 0.01% quaternary ammonium compound active to linen to as high as 0.25%, more preferably in the range of 0.025% to 0.20%.

The amount of water used to deliver this amount of solid softening composition can be any amount that can conveniently dissolve the desired dose in the required amount of time to deliver the softening composition to the rinse cycle of the machine. For example, using water from 45° C. to 55° C. a 100 g dose of softening composition is typically dispensed in from 1 to 4 minutes using from 2 to 10 liters of water.

The solid laundry softening compositions beneficially provide softness without causing any significant loss of water absorption or wicking to the treated linen. As one of the primary functions of certain linens, such as towels is to absorb water, it is undesirable for fabric softener actives to make the surface hydrophobic and decrease the amount of water that can be absorbed. The solid laundry softening compositions do not reduce water absorption—which can be measured by the distance water can wick up a treated linen in a fixed period of time (as outlined in the Examples).

Beneficially, the treated linens have premium softness in addition to whiteness, brightness and malodor removal. By softness, it is meant that the quality perceived by users through their tactile sense to be soft. Such tactile perceivable softness may be characterized by, but not limited to resilience, flexibility, fluffiness, slipperiness, and smoothness and subjective descriptions such as “feeling like silk or flannel.” In an embodiment, the softness resulting from the use of the solid laundry softening composition is at least equivalent to the softness preference exhibited by commercially available liquid fabric softener compositions.

The solid laundry softening compositions beneficially provide softness without causing any significant yellowing or discoloration to the treated linen. The yellowing gives the linens an unclean or unsavory appearance at best. As such, the use of quaternary ammonium fabric conditioners which cause yellowing may provide a nice feel, but shorten the overall life of a linen because the linen must be discarded before its otherwise useful life is exhausted. In the case of colored linens, yellowing is less obvious but the quaternary ammonium compounds cause a dulling of the colors over time. It is easily appreciated that it is desirable according to the compositions and methods disclosed herein to provide a fabric softening agent that does not cause significant yellowing or dulling of fabrics that are repeatedly washed and dried. Moreover, it is generally desirable for white laundry that is dried to remain white even after multiple drying cycles. That is, it is desirable that the fabric not yellow or dull after repeated cycles of drying. Yellowing or discoloration can be measured either directly visually or using a spectrophotometer, typically through “L,” “a,” and “b” values of the color scale. The color change is then reported as delta E (as outlined in the Examples) between treated and new linen. Typically, a value of delta E>1 is considered perceptible to the human eye and indicates discoloration, such as yellowing.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following chemical components were used in the listed examples:
Methyldiethanolamine (MDEA) ester quaternary ammonium compound (80%)
Triethanolamine (TEA) ester quaternary ammonium compound (85%)
Dihydrogenated tallow dimethyl ammonium chloride (DHTDMAC, 85%)
diamidoamine quaternary ammonium compound (90%)
High iodine number TEA esterquat (85%)
Fatty acid amide (such as a fatty acid monoethanolamide)
Emulsion of polydimethylsiloxane (30%)
Amino-functionalized polydimethylsiloxane (80%)
Sodium lauryl sulfate (SLS)
Amine oxide (such as Barlox 12)
Nonionic EO-PO reverse block copolymers
Nonionic alcohol ethoxylate surfactant (such as Surfonic L24-7)
Acidulant mixture of adipic, glutaric and succinic acid (such as Sokalan DCS)
Organosilicones such as aminosilicones which are hydrophobically modified silicones for softening boosting

### Example 1

Various quaternary ammonium compounds (quats) were evaluated to identify whether and to what extent these quaternary ammonium compounds could be loaded onto a solid urea-based softener composition while maintaining adequate hardness. Quaternary ammonium compounds evaluated included MDEA esterquat (a readily biodegradable quat with an iodine value <10), TEA esterquat (a readily biodegradable quat with an iodine value >10), DHTDMAC (a nonbiodegradable quat with an iodine value <10), Rewoquat WE-45 (a palm oil-based esterquat with an iodine value >20), and a diamidoamine quat (Accosoft 550, which has an iodine value ˜10). These quaternary ammonium compounds were incorporated into seven formulations according to Table 2.

TABLE 2

| | Form. 1 | Form. 2 | Form. 3 | Form. 4 | Form. 5 | Form. 6 | Form. 7 |
|---|---|---|---|---|---|---|---|
| Ingredient | (wt-%) | (wt-%) | (wt-%) | (wt-%) | (wt-%) | (wt-%) | (wt-%) |
| MDEA esterquat (80%) | 82 | 70 | 0 | | | | 30 |
| DHTDMAC (85%) | | | 40 | | | | 20 |
| TEA Esterquat (85%) | | | | 50 | | | |
| Diamidoamine quat | | | | | 40 | | |
| (90%) | | | | | | | |
| High iodine number | | | | | | 40 | |
| esterquat (85%) | | | | | | | |
| Silicone Emulsion | | 10 | 11 | 10 | 5 | 5 | 5 |
| (30% silicone in water) | | | | | | | |
| DI Water | 5 | | | | | | |
| Urea | 13 | 20 | 20 | 40 | 20 | 20 | 20 |
| Quat/Urea Ratio | 5.9 | 3.5 | 2.0 | 1.3 | 2.0 | 2.0 | 2.3 |

To evaluate the impact of quaternary ammonium compound and urea on formulation stability, 100-gram samples were prepared according to the formulations in Table 2. After the samples were prepared, they were chilled overnight below 0° C. Samples were placed in an oven upside down, and the temperature was increased in 5° C. intervals (leaving at least 16 hrs for equilibration) until some sample had fallen to the bottom of the cup. This was considered “flowability.”

To assess hardness using a Penetrometer, a given sample was placed on a penetrometer and penetrated for five seconds. The depth of penetration was measured in millimeters. The measuring process was then repeated for a total of three penetrations over different areas of the sample to arrive at an average. Generally, the penetrometer readings range from 0 mm to the height of the sample (about 32 mm). Penetrometer hardness is an indicator of sloughing because samples that become soft under high-humidity conditions are prone to falling apart either from gravity or the water pressure of a dispenser. As described herein a sufficiently hard composition has a penetrometer hardness (mm) of ≤8. Results are shown in Table 3.

TABLE 3

| | Form. 1 | Form. 2 | Form. 3 | Form. 4 | Form. 5 | Form.6 | Form. 7 |
|---|---|---|---|---|---|---|---|
| Penetrometer | 0.2 | 3 | 0.3 | 5 | 20 | 20 | 4 |
| Hardness (mm) | | | | | | | |
| Temperature before | >55° C. | >55° C. | 50-55° C. | 55° C. | <40° C. | <40° C. | 40-50° C. |
| Flowability (° C.) | | | | | | | |

Table 3 indicates that up to 82% of a quaternary ammonium compound (in particular an MDEA esterquat) can be loaded onto a composition comprising 14% urea and 4% water, while still maintaining good hardness and temperature robustness, when compared to a formulation containing the quaternary ammonium compound alone. A quat:urea ratio of about 6:1 is particularly useful in maintaining formulation robustness. Moreover, different quaternary ammonium compounds can be combined to achieve high quaternary ammonium compound loadings while maintaining product hardness (see, e.g. Form. 7) and if desired, a silicone emulsion may be used in place of water to further contribute to softness (see, e.g. Forms. 2-7). Beneficially, the silicones provide softening as a result of hydrophobic modification (e.g. aminosilicones).

### Example 2

A variety of processing aids were evaluated to determine which most efficiently aid in processability and dispensability of the softener formulations described in Example 1. Formulations were prepared according to Table 4, varying the amount of processing aid from 0 wt. % up to 11 wt. %.

TABLE 4

| | Form. P1 | Form. P2 | Form. P3 | Form. P4 |
|---|---|---|---|---|
| Ingredient | (wt. %) | (wt. %) | (wt. %) | (wt. %) |
| MDEA esterquat | 31 | 31 | 28 | 28 |
| Urea | 19 | 18 | 17 | 20 |
| Fatty acid amide | 0 | 2 | 11 | 0 |
| (processing aid) | | | | |
| DHTDMAC | 0 | 0 | 0 | 14 |
| Nonionic alcohol | 4 | 4 | 3 | 3 |
| ethoxylate | | | | |
| surfactant | | | | |
| Silicone in | 4 | 4 | 3 | 5 |
| solvent | | | | |
| Silicone | 5 | 5 | 4 | 3 |
| emulsion | | | | |
| Salt | 31 | 30 | 28 | 23 |
| Sodium Citrate | 6 | 6 | 6 | 4 |

The hardness of formulations P1-P4 was evaluated using the procedures described in Example 1. Viscosity was further assessed with a Brookfield RVT viscometer at 50 rpm, allowing the spindle to spin for at 1 minute before recording results. A formulation is considered processable if the viscosity is below 20 Pas at 75° C. The results of this analysis are shown in Table 5.

TABLE 5

| | Form. P1 | Form. P2 | Form. P3 | Form. P4 |
|---|---|---|---|---|
| Ingredient | (wt. %) | (wt. %) | (wt. %) | (wt. %) |
| Processable | No | Yes | Yes | Yes |
| Hardness (mm) | 5 | 2 | 0.3 | 5 |

Table 5 shows that incorporating a processing aid into the formulations does not inhibit or improves formulation stability. In particular, Formulations P2-P4 (all of which included a processing aid) demonstrated hardness as good as, or better than, Formulation P1 (which was free of a processing aid). The formulations containing the processing aid further demonstrated excellent processability.

### Example 3

A variety of surfactant packages were evaluated to determine which most efficiently aid in processability and dispensability of the softener formulations described in Example 1. Formulations were prepared according to Table 6, evaluating a variety of anionic, amine oxide, cationic, EO/PO nonionic, and other alkyl/ethoxylate nonionic surfactants.

TABLE 6

| | Form. S1 | Form. S2 | Form. S3 | Form. S4 | Form. S5 | Form. S6 | Form. S7 | Form. S8 |
|---|---|---|---|---|---|---|---|---|
| Ingredient | (wt. %) | (wt. %) | (wt. %) | (wt. %) | (wt. %) | (wt. %) | (wt. %) | (wt. %) |
| MDEA | 30 | 30 | 30 | 30 | 30 | 32 | 30 | 32 |
| Esterquat | | | | | | | | |
| Urea | 18 | 18 | 18 | 18 | 18 | 19 | 18 | 19 |
| Fatty acid | 2 | 2 | 2 | 2 | 2 | 3 | 2 | 3 |
| amide | | | | | | | | |
| Anionic | 0 | 0 | 0 | 0 | 0 | 4 | 0 | 0 |
| (sulfate) | | | | | | | | |
| Amine oxide | 0 | 0 | 0 | 0 | 4 | 0 | 0 | 0 |
| Reverse | 0 | 0 | 0 | 4 | 0 | 0 | 3 | 0 |
| EO/PO | | | | | | | | |
| surfactant | | | | | | | | |
| Nonionic | 4 | 0 | 0 | 0 | 0 | 0 | 3 | 0 |
| alcohol | | | | | | | | |
| ethoxylate | | | | | | | | |
| Silicone in | 4 | 4 | 4 | 4 | 4 | 4 | 4 | 4 |
| solvent | | | | | | | | |
| Silicone | 5 | 5 | 5 | 5 | 5 | 1 | 5 | 5 |
| emulsion | | | | | | | | |
| Salt | 30 | 30 | 30 | 30 | 30 | 32 | 30 | 32 |
| Sodium Citrate | 6 | 6 | 6 | 6 | 6 | 6 | 6 | 6 |

The hardness of formulations P1-P4 was evaluated using the procedures described in Example 1. Viscosity was further assessed by the methods described in Example 2. The results of this evaluation are shown in the Table 7.

TABLE 7

| | Form. S1 | Form. S2 | Form. S3 | Form. S4 | Form. S5 | Form. S6 | Form. S7 |
|---|---|---|---|---|---|---|---|
| Processable | Yes | Yes | Yes | Yes | No | Yes | Yes |
| Dispensable | Yes | Yes | No | No | No | No | Borderline |
| Hardness (mm) | 1 | 1 | 1 | 3 | 1 | 1 | 4 |

As shown in Table 7, several surfactants are suitable for improving the dispensability of the formulations. Although many surfactants are suitable, nonionic surfactants with an HLB value of between 10-15 and/or long alkyl chains beneficially improve dispensability without disrupting processability or product hardness.

### Example 4

Traditionally urea-based solid formulations are incompatible with acid, making incorporation of a sour into the formulation extremely difficult. The effect including an acid sour in the formulations was assessed by preparing several formulations according to Table 8. Hardness was then evaluated using the procedures described in Example 1.

TABLE 8

| | Form. S1 | Form. S2 | Form. S3 | Form. S4 | Form. S5 |
|---|---|---|---|---|---|
| Ingredient | (wt. %) | (wt. %) | (wt. %) | (wt. %) | (wt. %) |
| MDEA | 33 | 31 | 33 | 33 | 33 |
| esterquat | | | | | |
| Urea | 20 | 19 | 20 | 20 | 20 |
| Urea citrate | 7 | 13 | 0 | 0 | 0 |
| Citric acid | 0 | 0 | 7 | 0 | 0 |
| Sokalan | 0 | 0 | 0 | 7 | 0 |
| Nonionic | 4 | 4 | 4 | 4 | 4 |
| alcohol | | | | | |
| ethoxylate | | | | | |
| surfactant | | | | | |
| Silicone in | 4 | 4 | 4 | 4 | 4 |
| solvent | | | | | |
| Silicone | 5 | 5 | 5 | 5 | 5 |
| emulsion | | | | | |
| Salt | 27 | 25 | 27 | 27 | 27 |
| Sodium | 0 | 0 | 0 | 0 | 7 |
| citrate | | | | | |
| Hardness | 3 | 4 | 8 | 3 | 1 |
| (mm) | | | | | |

As shown in Table 8, an acid sour can successfully be incorporated in the formulations while still maintaining a hard solid. Thus, surprisingly, an optional acid sour can be added to the formulation without reducing the integrity or stability of the formulation.

### Example 5

As solid formulations heavily loaded with quaternary ammonium compounds typically lose stability in the presence of water, the water robustness of the solid formulations was evaluated. Formulations were prepared according to Table 9. Formulation W1 was dispensed on an Ecolab SCLS dispenser at 40-70° C. Formulation W3 had 3% water added to the formulation to test for robustness in the presence of water. Hardness was evaluated according to the procedures described in Example 1. Results are shown in Table 9.

TABLE 9

| | Form. W1 | Form. W2 |
|---|---|---|
| Ingredient | (wt. %) | (wt. %) |
| MDEA esterquat | 33 | 33 |
| Urea | 20 | 20 |
| Nonionic alcohol | 4 | 4 |
| ethoxylate surfactant | | |
| Silicone in solvent | 4 | 4 |
| Silicone emulsion | 5 | 5 |
| in water | | |
| Salt | 27 | 27 |
| Sodium citrate | 7 | 7 |
| Water | 0 | 3 |
| Hardness (mm) | 2 | 4 |

As shown by Table 9 and a visual assessment, both formulations maintained excellent hardness during dispensing, even under high temperature and high moisture conditions. Neither Formulation W1 nor Formulation W2 sloughed over the course of the capsule dispensing process.

### Example 6

Cotton towel samples were treated with softener formulations and softness was evaluated with a phabrometer. The cotton towel samples were prepared by running cotton towels through five double scouring cycles with a load weight of approximately 28 lbs. and drying between each cycle. Using a die press with an 11.3 cm circular die, sample swatches were cut from the scoured hand towels, such that there were at least four sample swatches per formulation evaluated. The swatches were labeled according to their test condition. 1500 mL beakers were placed on a hotplate with a stir bar and 500 mL of DI water.

Temperature was set to 40° C. and the stir bars were set to spin at 400 RPM. The desired type and quantity of softening formulation as outlined in Table 8, formulation S 1, was delivered to each beaker. MDEA esterquat was dosed at 40 ppm per 25 g towels, with a 6:1 ratio of quat:surfactant, while TEA esterquat was dosed at 60 ppm per 25 g towels, with a 10:1 ratio of quat:surfactant. The beakers were then allowed to mix thoroughly and reach the desired temperature. After mixing, swatches were added one at a time to their respective beakers and were allowed to mix for six minutes. After six minutes, the solution was emptied from each beaker and the swatches were extracted and allow to dry for 20 minutes. All swatches were then placed in a humidity chamber and allowed to sit overnight at 40% humidity.

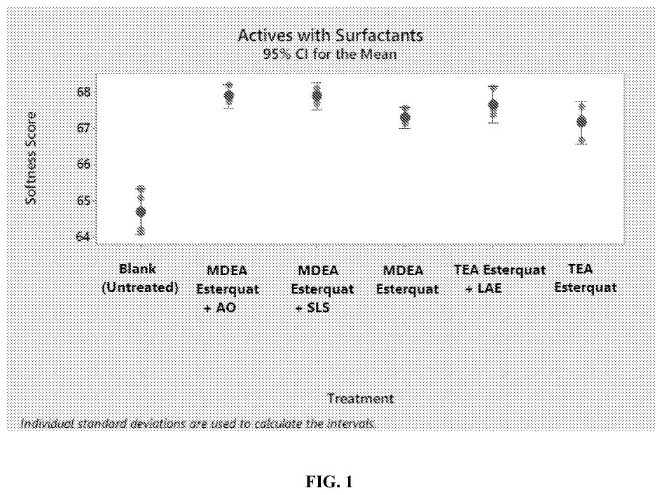

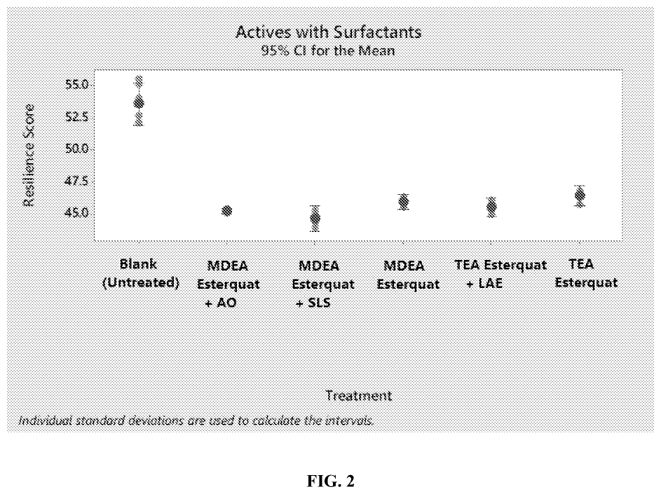

Fabric analysis was conducted in the phabrometer, where the swatches were individually weighed down and forced through an orifice while measuring/calculating the attributes of softness and resilience. The treated fabrics were compared to a blank, or a control of TEA esterquat at 60 ppm (commercially available quat silicone softener). In general, a larger softness value is attributed to a softer fabric. A larger resilience value is attributed to a more resilient fabric. The results of the analysis in the phabrometer are shown in FIG. 1 and FIG. 2, where the blank is an untreated towel without any softness treatment. FIGS. 1 and 2 show that the formulations of the application beneficially maintain good fabric softness without significantly impacting the integrity of the fabric. The results are assessed in comparison to a TEA esterquat Control where an equivalent or improved softening is desired.

### Example 7

Additional ratios of quaternary ammonium compound:urea were tested, 1:1, 3:1, and 8:1 to evaluate processability and dispensability. Formulations were prepared according to Table 10. Formulations were dispensed on an Ecolab SCLS dispenser at 50° C. Results are shown in Table 10.

TABLE 10

| | Form. S1A | Form. S2A | Form. S3A |
|---|---|---|---|
| Ingredient | (wt. %) | (wt. %) | (wt. %) |
| MDEA Esterquat | 27 | 30 | 60 |
| Urea | 27 | 10 | 10 |
| Fatty acid amide | 5 | 3 | 3 |
| Anionic (sulfate) | 0 | 0 | 0 |
| Amine oxide | 0 | 0 | 0 |
| Reverse EO/PO | 0 | 0 | 0 |
| surfactant | | | |
| Nonionic alcohol | 4 | 4 | 3 |
| ethoxylate | | | |
| Silicone in | 3 | 3 | 0 |
| solvent | | | |
| Silicone emulsion | 8 | 8 | 8 |
| Salt | 27 | 42 | 16 |
| Processability | Yes | Yes | Yes |
| Dispensability | No | Yes | No |
| Hardness | 0 mm | 5 mm | 4 mm |

The dispensability of the solid compositions using the SCLS dispenser at 50° C. required conductivity of the dispensed solution of the solid laundry softening composition reach at least 1000 uS/cm within 1 minute to meet ‘dispensability’ requirements. The processability threshold is that processing viscosity is below 20 Pa s at 75° C. The hardness was measured with a penetrometer according to the methods described in Example 1.

As shown the data confirm that the ratio of quaternary ammonium compound to urea or occlusion compound forming derivatives is preferred between about 1:1 to less than 8:1, or about 1:1 to about 6:1, to provide a solid composition that is dispensable and processable. The 8:1 quat:urea in Form S3A was not dispensable, which appears to be more dependent on salt concentration (as confirmed with conductivity requirement) than quat:urea ratio. The results also show that the hardness is at least partially dependent on the quat:urea ratio, with below 3:1 ratio preferred, while the range of ratios 1:1 to 6:1 provide solid, dispensable solid compositions when there is salt in the formula to promote high conductivity.

The processability assessed was not controlled by the quat:urea ratio; instead, fatty acid amide dosage impacts this attribute of the solid compositions. Although higher urea:quat have lower initial viscosities, the viscosity can be adjusted by the addition of higher level of fatty acid amide.

The various embodiments being thus described, it will be apparent that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. A solid laundry softening composition comprising:
from about 10-60 wt-% of a quaternary ammonium compound having the formula: 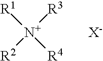
wherein R¹ and R² represent the same or different hydrocarbyl groups having from 8 to 24 carbon atoms, R³ and R⁴ represent the same or different hydrocarbyl groups containing 1 to about 4 carbon atoms, and X is an anion; and
from about 1 wt-% to about 25 wt-% urea or occlusion compound forming derivatives;
wherein the ratio of quaternary ammonium compound to urea or occlusion compound forming derivatives is from about 1:1 to about 6:1; and
wherein the solid composition is dispensable and processable.

2. The composition of claim 1, wherein the quaternary ammonium compounds comprise from about 15 wt-% to about 60 wt-% of the solid laundry softening composition, and wherein the urea or occlusion compound forming derivatives comprise from about 1 wt-% to about 20 wt-% of the solid laundry softening composition.

3. The composition of claim 1, wherein the quaternary ammonium compound comprises a dialkyl quaternary ammonium compound comprising a di-C8-24 alkyl dimethyl quaternary ammonium compound or di(hydrogenated tallowalkyl)dimethyl ammonium chloride (DHTDMAC).

4. The composition of claim 1, wherein the quaternary ammonium compound comprises an ester quat, amidoamine, imidazoline, esteramide salt, or combinations thereof.

5. The composition of claim 1, further comprising a softening booster in the amount of between about 0.1 wt-% to about 20 wt-% of the solid composition.

6. The composition of claim 5, wherein the softening booster is a silicone emulsion and/or an organosilicone comprising a polyalkyl silicone, an aminosilicone, a siloxane, a polydimethyl siloxane, an ethoxylated organosilicone, a propoxylated organosilicone, an ethoxylated/propoxylated organosilicone, or mixtures thereof, or wherein the softening booster is a deposition aid.

7. The composition of claim 1, further comprising a processing aid.

8. The composition of claim 7, wherein the processing aid contains a C6-C22 alkyl group in the amount of about 0.5 wt-% to about 10 wt-% of the solid composition.

9. The composition of claim 1, further comprising a salt, acid, surfactant, and/or other additional functional ingredient.

10. The composition of claim 9, wherein the surfactant is a nonionic, amphiphilic, anionic, or cationic surfactant.

11. The composition of claim 1, wherein the solid composition is a multi-use composition that is at least 250 grams, and/or wherein the solid is a cast or extruded solid, and wherein the solid is a capsule, tablet, puck, brick or block.

12. A solid laundry softening composition comprising:
from about 15-60 wt-% of a quaternary ammonium compound having the following formula: 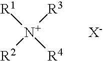
wherein R¹ and R² represent the same or different hydrocarbyl groups having from 12 to 24 carbon atoms, R³ and R⁴ represent the same or different hydrocarbyl groups containing 1 to about 4 carbon atoms, and X is an anion;
from about 1 wt-% to about 25 wt-% urea or occlusion compound forming derivatives;
a surfactant providing fabric softness and/or dispensing and processing improvement;
wherein the ratio of quaternary ammonium compound to urea or occlusion compound forming derivatives is from about 1:1 to about 6:1; and
wherein the solid composition is dispensable and processable.

13. The composition of claim 12, wherein the quaternary ammonium compounds comprise from about 15 wt-% to about 55 wt-% of the solid laundry softening composition, and wherein the urea or occlusion compound forming derivatives comprise from about 5 wt-% to about 20 wt-% of the solid laundry softening composition.

14. The composition of claim 12, wherein the quaternary ammonium compound comprises a dialkyl quaternary ammonium compound, an ester quat, amidoamine, imidazoline, esteramide salt, or combinations thereof, and wherein the quaternary ammonium compound has an iodine value less than or equal to 15.

15. The composition of claim 12, further comprising a softening booster in the amount of between about 0.1 wt-% to about 20 wt-% of the solid composition.

16. The composition of claim 15, wherein the softening booster is a silicone emulsion and replaces water added to the formulation to form the solid composition.

17. The composition of claim 12, further comprising one or more of (A) a processing aid, wherein the processing aid comprises a C6-C22 alkyl group in the amount of about 0.5 wt-% to about 10 wt-% of the solid composition, (B) a salt, (C) an acid, (D) a surfactant, or (E) an additional functional ingredient.

18. The composition of claim 12, wherein the solid composition is a multi-use composition that is at least 250 grams, and/or wherein the solid is a cast or extruded solid, and wherein the solid is a capsule, tablet, puck, brick or block.

19. A method for treating fabric, the method comprising:
(a) contacting a solid laundry softening composition with water to form an aqueous suspension, wherein the solid laundry softening composition comprises: from about 10-60 wt-% of a quaternary ammonium compound having the formula: 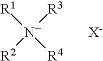
wherein R¹ and R² represent the same or different hydrocarbyl groups having from 8 to 24 carbon atoms, R³ and R⁴ represent the same or different hydrocarbyl groups containing 1 to about 4 carbon atoms, and X is an anion; and from about 1 wt-% to about 25 wt-% urea or occlusion compound forming derivatives; wherein the ratio of quaternary ammonium compound to urea or occlusion compound forming derivatives is from about 1:1 to about 6:1; and wherein the solid composition is dispensable and processable; and
(b) dispensing the aqueous suspension into a washing machine, where it contacts the fabric to be treated.

20. The method of claim 19, wherein the treated fabric does not exhibit yellowing or fabric color change as measured by value of delta E>1.

21. The method of claim 19, wherein the dispensing of the aqueous suspension is at least about 10 grams/minute with water at a temperature between about 40° C. and 60° C.
